(19) United States
(12) Patent Application Publication
(10) Pub. No.: US 2016/0120194 A1
(43) Pub. Date: May 5, 2016

(54) FOOD PREPARATION SHAPING ASSEMBLY AND METHOD

(71) Applicant: Robert L. Weber, St. Louis, MO (US)

(72) Inventor: Robert L. Weber, St. Louis, MO (US)

(21) Appl. No.: 14/927,206

(22) Filed: Oct. 29, 2015

Related U.S. Application Data
(60) Provisional application No. 62/069,933, filed on Oct. 29, 2014.

(51) Int. Cl. A22C 7/00

(52) U.S. Cl. CPC A22C 7/0076; A23P 1/105

(57) ABSTRACT

A food preparation assembly and method with a selectable assembled tower assembly having a plurality of food mold bodies stacked together, each food mold body having an outer body and a through molding cavity with each having a different predefined molding shape, the tower assembly including a plurality of food molding plungers with each having a shape that is substantially similar to one of the predefined shapes of each molding cavity and each of the plurality of food molding plungers being selectable positioned and inserted within the correspondingly shaped molding cavity when assembled in the assembled tower assembly, the tower assembly being selectable disassembled into separately usable food mold bodies with separately usable food molding plungers.

### CROSS-REFERENCE TO RELATED APPLICATIONS

This application claims the benefit of U.S. Provisional Application No. 62/069,933, filed on Oct. 29, 2014, the disclosure of which is incorporated herein by reference.

### FIELD

The present disclosure relates to food preparation, and more specifically, to an assembly and method of use thereof for preparation foods such as meat product into particular shapes.

### BACKGROUND

The statements in this section merely provide background information related to the present disclosure and may not constitute prior art.

There is a need for a compact assembly and method of producing shaped food products during preparation. This includes the shaping of ground or chopped meat.

### SUMMARY

The inventor hereof has succeeded at designing assemblies and methods of use for a food preparation assembly capable of shaping food products such as a chopped or ground meat, by way of example, into various desired shapes in a cost effective manner and wherein such assembly is cost effective and easily stored by the user.

According to one aspect, a food preparation assembly and method with a selectable assembled tower assembly has a plurality of food mold bodies stacked together. Each food mold body has an outer body and a through molding cavity with each having a different predefined molding shape. The tower assembly includes a plurality of food molding plungers with each having a shape that is substantially similar to one of the predefined shapes of each molding cavity and each of the plurality of food molding plungers being selectable positioned and inserted within the correspondingly shaped molding cavity when assembled in the assembled tower assembly. The tower assembly can be selectable disassembled into separately usable food mold bodies with separately usable food molding plungers during use by a user in preparing molding food and reassembled into the tower assembly after use for storage.

In another aspect, an assembly having a plurality of food mold bodies with each having an outer body and a through cavity with a different predefined molding shape. The assembly also includes a plurality of molding plungers with each having a top side with a handle and a bottom plunger body having a shape substantially similar to a different one of the predefined shapes of one of the plurality of mold bodies and dimensioned for insertion into the similarly shaped mold body cavities, and a bottom molding surface for contacting the food when placed within the cavity.

According to another aspect, a food preparation assembly includes a base plate having a substantially planar profile with a top molding surface and a bottom molding surface, at least one of the top and bottom molding surface include a mating feature proximate to a perimeter. The assembly also includes an outer mold body having a bottom surface with a mating feature couplable to the mating feature of the base plate and having a cavity with a first predefined shape. The assembly further includes a plurality of inner mold bodies with each configured for usable placement and selective retention within the cavity of the outer mold body and each having a predefined inner moldable shape cavity of a different molding shape. Also included is a plurality of molding plungers with each having a top side with a handle and a bottom plunger body that has a shape substantially similar to a different one of the moldable shaped cavities of one of the inner mold bodies, and each having a bottom molding surface.

According to another aspect, a food preparation method includes placing a mold body at least one of a working surface or a base placed upon the working surface, the mold body having a cavity with a predefined shape and placing a food product in the cavity of the mold body. The method includes placing a mold plunger onto the food product within the mold body cavity with the plunger having a shape that is substantially similar to that and which conforms to the shape of the predefined shape of the mold body. The method thereafter includes applying downward molding pressure to a handle of the mold plunger, removing the mold plunger after applying the downward molding pressure, and removing the mold body from about the molded food product.

According to yet another aspect, a food preparation method includes placing a base on a working surface, placing an outer mold body on the working surface, wherein the outer mold body has a cavity for receiving an inner mold body with a molding cavity shape, and placing an inner mold body with the molding cavity shape within the cavity of the outer mold body. The method also includes placing a food product in the molding cavity of the inner mold body, placing a mold plunger onto the food product within the inner mold body cavity. The plunger has a shape that is substantially similar to that and which conforms to the shape of the predefined molding cavity shape of the inner mold body. The method also includes applying downward molding pressure to a handle of the mold plunger, removing the mold plunger after applying the downward molding pressure, and removing the inner mold body from about the molded food product.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 includes FIGS. 1A and 1B that are top perspective views of two food preparation assemblies with FIG. 1A having one-piece a rib-shaped food mold and FIG. 1B having a two-piece rib-shaped food mold according to two different exemplary embodiments.

FIG. 2 includes FIGS. 2A and 2B that are top perspective views of two food preparation assemblies with FIG. 2A having a one-piece round shaped food mold and FIG. 2B having a two-piece round shaped food mold according to two additional exemplary embodiments.

FIG. 3 includes FIGS. 3A and 3B that are top perspective views of two food preparation assemblies with FIG. 3A having a one-piece round 2-slider shaped food mold and FIG. 3B having a two-piece round 3-slider shaped food mold according to two additional exemplary embodiments.

FIG. 4 includes FIGS. 4A and 4B that are top perspective views a food preparation assembly having a plurality of different shaped one-piece food molds, with FIG. 4A illustrating the assembly in a disassembled configuration and FIG. 4B illustrating the assembly in an assembled assembly according to one exemplary embodiment.

FIG. 5 includes FIG. 5A that is a top perspective view of a round food mold body, FIG. 5B that is a top perspective view of a round food molding plunger body, and FIG. 5C that is a top perspective view of an attachable food mold face plate for the food molding plunger body, and FIG. 5D is a bottom perspective view of the attachable food mold face plate of FIG. 5C, each according to one set of exemplary embodiments.

FIG. 6 includes FIG. 6A that is a top perspective view of a slider mold body, FIG. 6B that is a top perspective view of a slider molding plunger body, each according to one exemplary embodiment.

FIG. 7 includes FIG. 7A that is a top perspective view of a chop-shaped food mold body, FIG. 7B that is a top perspective view of a chop-shaped food molding plunger body, each according to one exemplary embodiment.

FIG. 8 includes FIG. 8A that is a top perspective view of a rib-shaped food mold body, FIG. 8B that is a top perspective view of a rib-shaped food molding plunger body, each according to one exemplary embodiment.

FIG. 9 includes FIG. 9A that is a top perspective view of a helmet-shaped food mold body, FIG. 9B that is a top perspective view of a helmet-shaped food molding plunger body, each according to one exemplary embodiment.

FIG. 10 includes FIG. 10A that is a top perspective view of a dinosaur-shaped food mold body, FIG. 10B that is a top perspective view of a dinosaur-shaped molding plunger body, each according to one exemplary embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

In one exemplary embodiment, a food preparation assembly and method with a selectably assembled tower assembly has a plurality of food mold bodies stacked together. Each food mold body has an outer body and a through molding cavity with each having a different predefined molding shape. The tower assembly includes a plurality of food molding plungers with each having a shape that is substantially similar to one of the predefined shapes of each molding cavity and each of the plurality of food molding plungers being selectably positioned and inserted within the correspondingly shaped molding cavity when assembled in the assembled tower assembly. The tower assembly can be selectably disassembled into separately usable food mold bodies with separately usable food molding plungers during use by a user in preparing molding food and reassembled into the tower assembly after use for storage.

In one embodiment, a food preparation assembly including a base plate having a substantially planar profile with a top molding surface and a bottom molding surface, at least one of the top and bottom molding surface include a mating feature proximate to a perimeter. The assembly also having a mold body having a bottom surface with a mating feature couplable to the mating feature of the base plate and having a cavity with a predefined molding shape and a molding plunger having a top side with a handle and a bottom plunger body having a shape substantially similar to the predefined shape of the mold body, and a bottom molding surface.

Examples of these embodiments are shown in the Figures as will be addressed below by way of examples. As shown in these exemplary figures, there can be multiple mold bodies and molding plungers, each having a different mold shape. Wherein there is a first mold body having a first predefined molding shape, and the molding plunger is a first molding plunger, then the assembly can include a second mold body having a bottom surface with a mating feature couplable to the mating feature of the base plate and having a cavity with a second predefined molding shape for receiving a molding plunger, the second predefined shape being different than the first defined shape and a second molding plunger having a top side with a handle and a bottom plunger body having a shape substantially similar to the second predefined molding shape of the second mold, and a bottom molding surface.

For ease of stacking of such, the molding plungers with the handle can have a vertical dimension that is substantially equivalent or slightly less than the vertical dimension of the mold body. The assembly can be configured and dimensioned to be assembled with the first mold body selectively mounted onto the top molding surface of the base plate with the first molding plunger positioned within the cavity thereof and the second mold body selectively mounted to a top surface of the second mold body with the second molding plunger positioned within the cavity thereof.

While shown in some of the figures as an octagon outer shape, the outer shape can be any shape including an octagon, a circle, an oval, a triangle, a square or a rectangle. Wherein the molding shapes of one or more of the mold body molding cavities and mating molding plunger is shown in the figures by way of example as a large patty circle, a small patty or slider circle, a rib, and a chop, these shapes can be any shape.

As shown, the base plate, when provided, can include a drip trough feature about a periphery on at least the first side or the second side. Each first molding surface of the base plate can be substantially smooth and the opposite side or second molding surface of the base plate can be different texture such as a chopped or cross-checked pattern or texture.

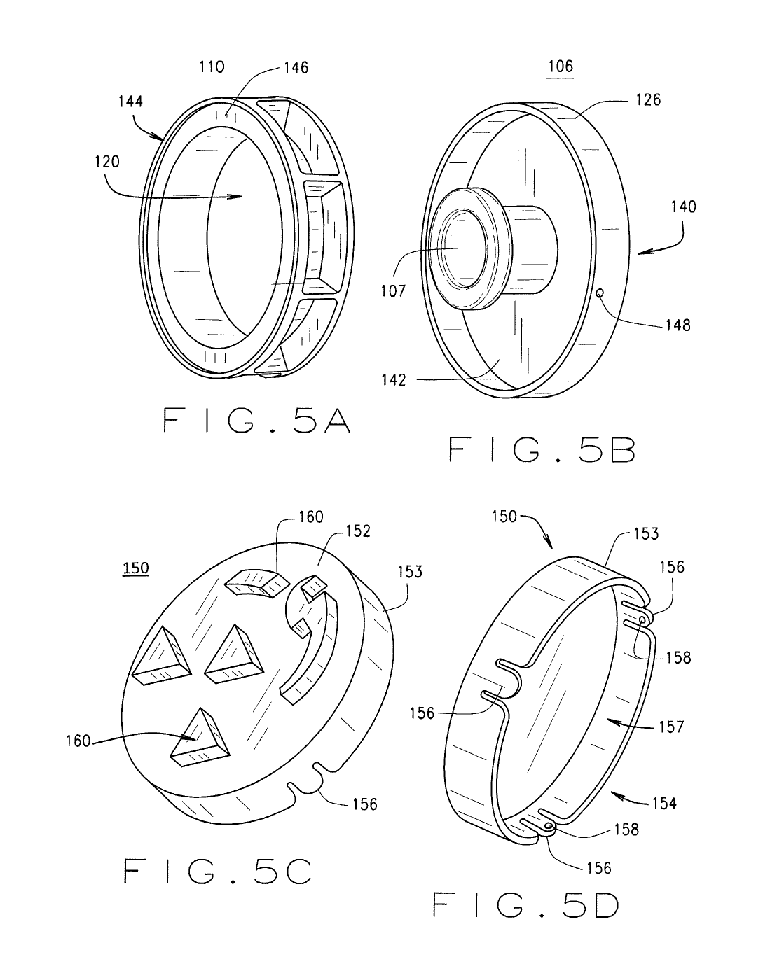

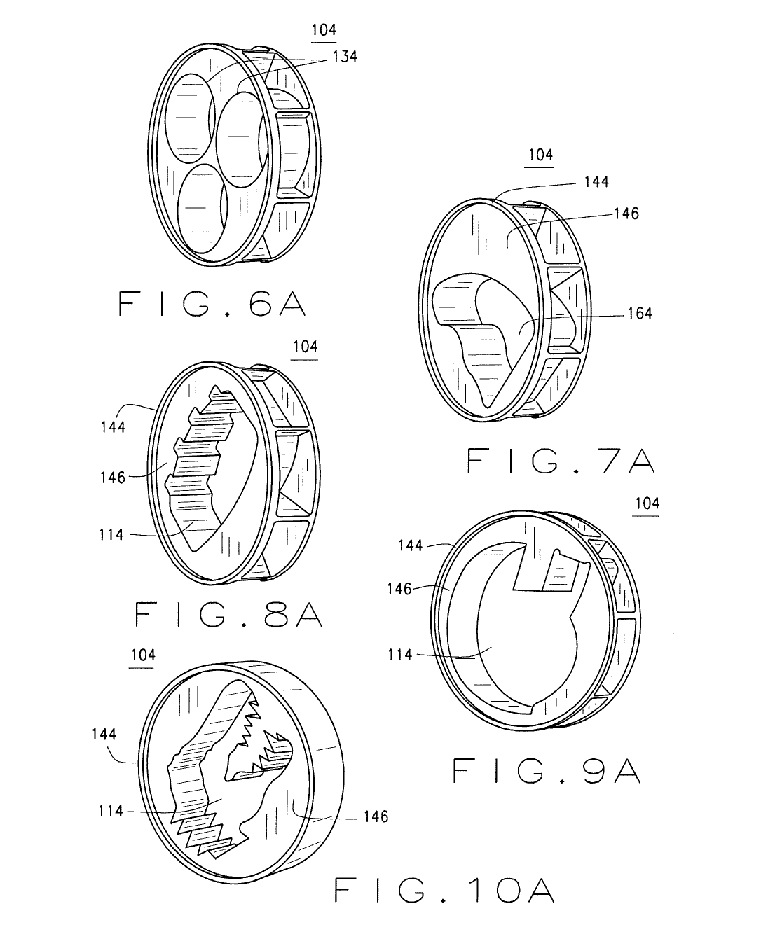

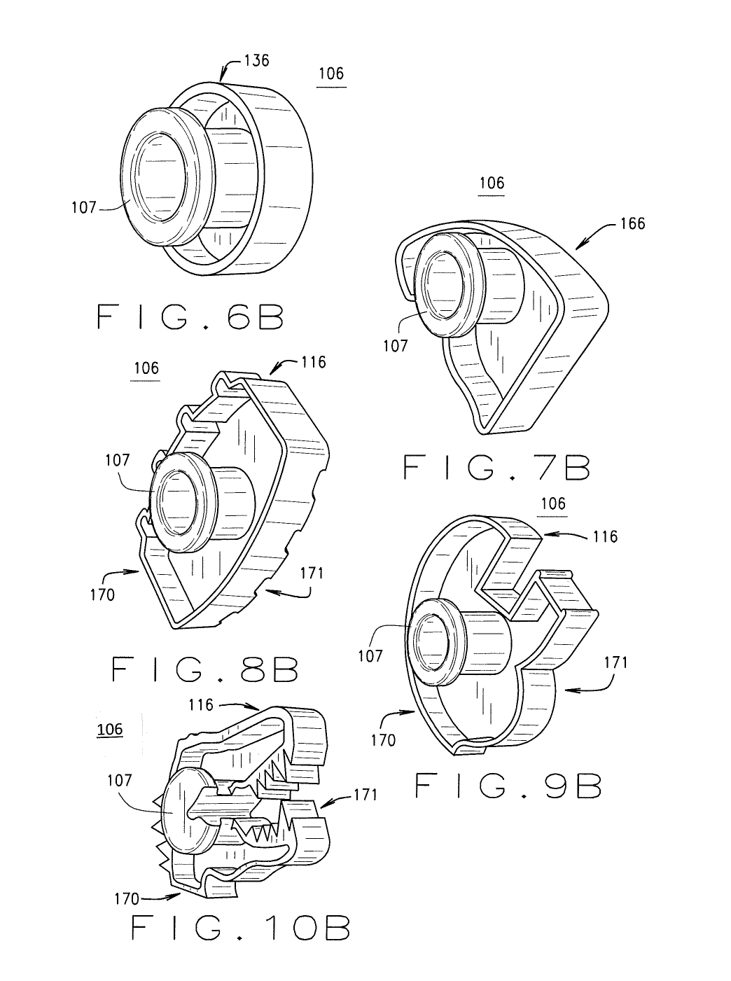

Further, the food mold plunger can be a fixed shape or can include an attachment mechanism or means for attaching a molding surface as shown in FIGS. 6B, 7B, 8B, 9B and 10B. In some embodiments, as shown in FIGS. 6B, 7B, 8B, 9B and 10B the food plunger can be a unibody or monolithic construction, and in other embodiments, such as shown in FIGS. 5B, 5C and 5D, the food plunger can be of a two-piece construction. As such, in these latter embodiments, the food molding plunger with an upper body has a top side and a handle and the bottom side that includes a selective attachment mechanism for selectively attaching the bottom molding surface to the upper body

In one embodiment of use of such an assembly, a food preparation method includes placing a base on a working surface and placing a mold body on the base, the mold body having a cavity with a predefined shape. The method includes placing a food product in the cavity of the mold body and placing a mold plunger onto the food product within the mold body cavity, the plunger has a shape that is substantially similar to that and which conforms to the shape of the predefined shape of the mold body. The method also includes applying downward molding pressure to a handle of the mold plunger, removing the mold plunger after applying the downward molding pressure, and removing the mold body from about the molded food product.

The method can also include that prior to the step of placing the base on the working surface, disassembling a stack of a plurality of mold bodies with each having a differently shaped molding cavity, each stacked on top of each other and all of which are stacked on top of the base, and further removing a plurality of molding plungers from each of the molding cavities with each having a shape that conforms substantially with a different one of the shaped molding cavities.

This can include prior to the placing the mold plunger, selectively attaching a molding surface body to an upper body of the molding plunger that defines a top handle such as shown in FIGS. 5B, 6B, 7B, 8B, 9B and 10B, by ways of example. The food molds can have a substantially similar mold shape as shown in FIGS. 5A, 6A, 7A, 8A, 9A, and 10A, respectively.

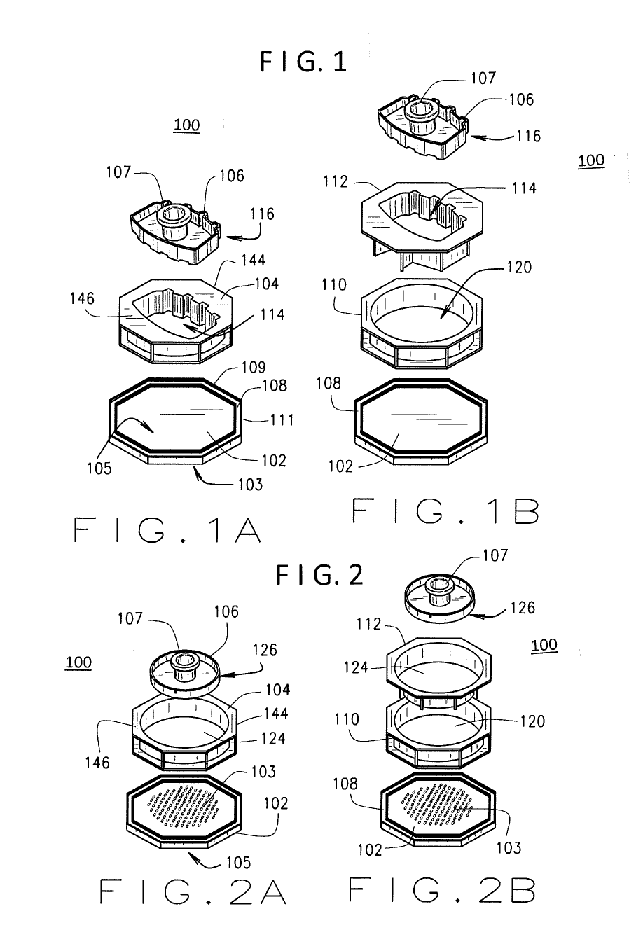

In another embodiment a food preparation assembly includes a base plate having a substantially planar profile with a top molding surface and a bottom molding surface, at least one of the top and bottom molding surface include a mating feature proximate to a perimeter. The assembly includes an outer mold body having a bottom surface with a mating feature couplable to the mating feature of the base plate and having a cavity with a first predefined shape and an inner mold body configured for usable placement and selective retention within the cavity of the outer mold body and having a moldable shape cavity. The assembly also includes a molding plunger having a top side with a handle and a bottom plunger body having a shape substantially similar to the moldable shape cavity of the inner mold body, and a bottom molding surface. Examples of these embodiments are shown in FIGS. 1B, 2B, and 3B. The inner mold body is a first inner mold body and the molding plunger is a first molding plunger with a first shape.

In some embodiments, a second inner mold body configured for usable placement and selective retention within the cavity of the outer mold body and having a second moldable shape cavity that is different from the shape of the first moldable shape cavity and a second molding plunger having a top side with a handle and a bottom plunger body having a shape substantially similar to the moldable shape cavity of the second inner mold body, and a bottom molding surface.

In some embodiment, the assembly includes the second molding plunger with the handle has a vertical dimension that is substantially equivalent or slightly less than the vertical dimension of the outer mold body. This enables the stacking and compact assembly when the not in use.

In one embodiment of use of such an assembly, a food preparation method includes placing a base on a working surface and placing a mold body on the base, the mold body having a cavity with a predefined shape. The method includes placing a food product in the cavity of the mold body and placing a mold plunger onto the food product within the mold body cavity, the plunger have a shape that is substantially similar to that and which conforms to the shape of the predefined shape of the mold body. The method also includes applying downward molding pressure to a handle of the mold plunger, removing the mold plunger after applying the downward molding pressure, and removing the mold body from about the molded food product.

In another embodiment of a method of use of this embodiment of the assembly, a food preparation method includes placing a base on a working surface, placing an outer mold body on the working surface, wherein the outer mold body has a cavity for receiving an inner mold body with a molding cavity shape, and placing an inner mold body with the molding cavity shape within the cavity of the outer mold body. The method also includes placing a food product in the molding cavity of the inner mold body and placing a mold plunger onto the food product within the inner mold body cavity, the plunger have a shape that is substantially similar to that and which conforms to the shape of the predefined molding cavity shape of the inner mold body. The method further includes applying downward molding pressure to a handle of the mold plunger, removing the mold plunger after applying the downward molding pressure and removing the inner mold body from about the molded food product.

The method can include after removing the inner mold body from the molded food product, removing the inner mold body from the outer mold body.

This can also include placing a second inner mold body configured for usable placement and selective retention within the cavity of the outer mold body and having a second moldable shape cavity that is different from the shape of the first moldable shape cavity; placing a second food product in the second molding cavity of the second inner mold body; placing a second molding plunger having a top side with a handle and a bottom plunger body having a shape substantially similar to the moldable shape cavity of the second inner mold body; applying a second downward molding pressure to a handle of the second mold plunger; removing the second mold plunger after applying the second downward molding pressure; and removing the second inner mold body from about the second molded food product.

In some embodiment, the method includes after removing the second inner mold body from the second molded food product, removing the second inner mold body from the second outer mold body.

Referring now to the various exemplary embodiments as illustrated in the Figures.

FIG. 1 includes FIGS. 1A and 1B that are top perspective views of two food preparation assemblies 100 with FIG. 1A having one-piece a rib-shaped food mold and FIG. 1B having a two-piece rib-shaped food mold according to two different exemplary embodiments. As shown in FIG. 1A, the assembly 100 can include a base plate or base 102, a food mold 104 and a food plunger 106. The base 102 has a bottom surface 103 and a top surface 105. The mold 104 can be of any shape and in this illustrated embodiment has an outer shape that is octangular as defined by mold perimeter 144. The mold 104 defines a through molding cavity 114 having a predefined shape for shaping food placed therein. The food plunger 106 has a handle 107 on top for user manipulation of the food plunger 106 to place it within the substantially similarly shaped molding cavity 114 of the mold 104. For insertion into the molding cavity 114, the food plunger 106 should have an outer dimension that is slightly smaller or reduced as compared to the similarly shaped molding cavity 114, which is shown in FIG. 1A as each being in rib steak shape 116. The base plate 102 can also include a drip trough 108 about its perimeter to retain fluids that may be excreted by the food product during pressing and molding. The base plate 102 can also have an outer raised edge 109 or lip that is raised and dimensioned for receiving and seating the perimeter of the mold 104 onto the upper surface 105 of the base plate 102 during storage as a stacked tower assembly as well as during use for retaining the mold 104 onto to the top surface 105 of the base plate 102. Of course, one of skill in the art should understand from a review of this specification, that different combinations of molds 104 and plungers 106 can have different substantially similar mating shapes that are predetermined to be of different shapes and can be of any shape as may be desired that can be predefined and each component molded to form such shapes.

As also will be addressed below and as is shown in the comparison of FIG. 1A and FIG. 2A depiction of embodiments of the base plate 102, one or both of the upper surface 105 and the lower surface 103 of the base plate 102 can include a molding pattern such as illustrated in FIGS. 2A and 2B. In this manner, the base plate can be inverted so that the molding can be on upper surface 105 to provide a first molding texture to the molded food and then inverted so that the molding can be on the lower surface 103 to provide a second and different molding texture to the molded food.

FIG. 1B differs from FIG. 1A in that in lieu of a having a unibody or monolithic construction of the mold 104, the assembly 100 rather includes a two-piece molding arrangement composed of a first body that is an outer mold body 110 that defines a large center cavity 120 and a second body that is a mold shape insert 112 that includes the predefined shaped food molding cavity 114. The mold shape insert 112 is configured and dimensioned to fit and be operable within the large center cavity 120 of the outer mold body 110. Otherwise, the exemplary embodiment of FIG. 1B is substantially similar to that described above with regard to FIG. 1A.

Each of the base plate 102, the mold 104, out mold body 110 and inner mold shape insert 112 and the plunger 106 can be formed of any type of suitable material for handling and processing of food products, such as raw meats, by way of example.

FIG. 2 includes FIGS. 2A and 2B that are top perspective views of two food preparation assemblies 100 with FIG. 2A having a one-piece round shaped food mold and FIG. 2B having a two-piece round shaped food mold according to two additional exemplary embodiments. Each of these FIGS. 2A and 2B are substantially similar to that described above with regard to FIGS. 1A and 1B, respectively, except that FIGS. 2A and 2B illustrate that the molding cavity 124 and plunger 106 for molding of the food product has a substantially large round shape 126, such as for a round hamburger patty. Further, as addressed above, the base plate 102 is shown as being inverted such that the bottom surface 103 is on top and has a pattern thereon for providing a patterned texture to the food product when pressed onto the base plate 102 during pressing of the plunger 106 into the mold cavity 124 when the mold is placed on the base plate 102 during such pressing.

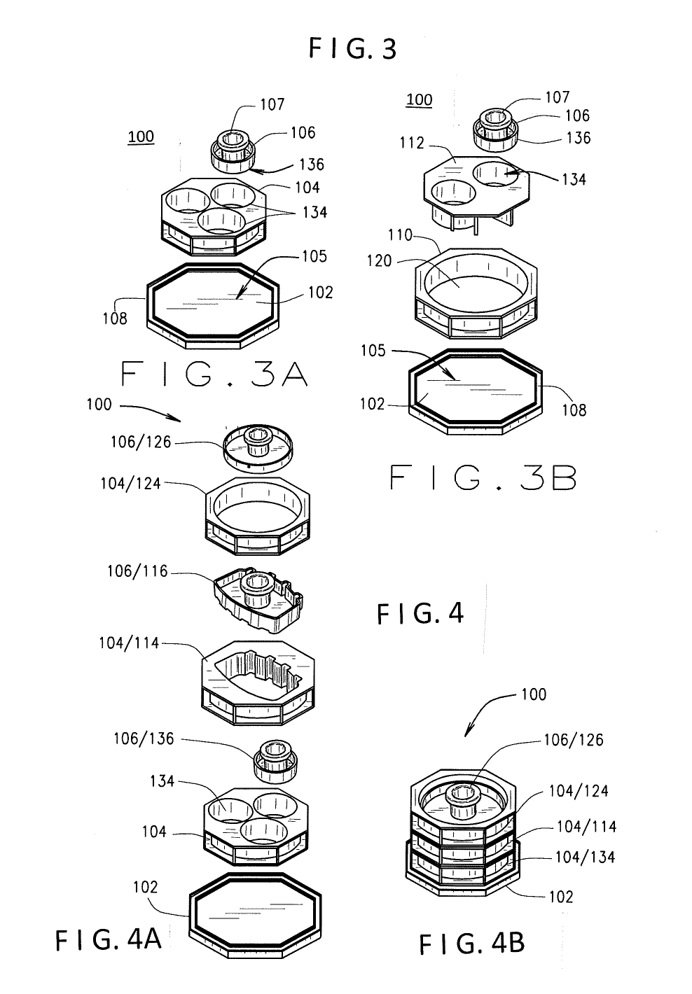

FIG. 3 includes FIGS. 3A and 3B that are top perspective views of two food preparation assemblies 100 with FIG. 3A having a one-piece round 2-slider shaped food mold and FIG. 3B having a two-piece round 3-slider shaped food mold according to two additional exemplary embodiments. Each of these FIGS. 23 and 3B are substantially similar to that described above with regard to FIGS. 1A and 2A and FIGS. 1B and 2B, respectively, except that FIGS. 32A and 3B illustrate that the mold 104 includes a plurality of smaller circular molding cavities 134 (FIG. 3A having three (3) and FIG. 3B having two (2) showing two examples) and the plunger 106 for molding of the food product has a substantially round shape 136 that is dimensioned for insertion into the smaller molding cavities 134, such as for making a three round “slider” patties in a molding by separately pressing food placed in each of the smaller molding cavities 134 with the plunger 106.

FIG. 4 includes FIGS. 4A and 4B that are top perspective views a food preparation assembly 100 having a plurality of different shaped one-piece food molds, with FIG. 4A illustrating the assembly in a disassembled configuration and FIG. 4B illustrating the assembly in an assembled stacked tower assembly 100 according to one exemplary embodiment. Referring first to FIG. 4A illustrates, by way of one exemplary embodiment, a tower assembly 100 having the base plate 102 with the three previously described unibody molds 104 with cavities 134 of FIG. 3A, and plunger 106 with shape 136 being positioned next to and on top of base plate 102. Next, on top of that assembly, mold 104 with cavity 114 as illustrated in FIG. 1A and with similarly shaped plunger 106 having the rib shape 116. On top of that assembly, mold 104 having round cavity 124 with plunger 106 with the shape 126. FIG. 1A is the disassembled or exploded view of the tower assembly 100 wherein FIG. 4B illustrates the assembled three molds 104 with cavity 134, 104 with cavity 114 and 104 with cavity 124, and having only plunger 106 with shape 126 being visible at that the top. While not shown in FIG. 4B, plunger 106 with shape 136 is inserted and contained within one of the cavities 134 of mold 104 with cavities 134 and plunger 106 with shape 116 is inserted within the cavity 114 of mold 114 with cavity 114 within the assembled tower 100 of FIG. 4B. In this manner, as shown in FIG. 4B, all three molds 10 with the different mold cavities 134, 114 and 124 and each of their similarly shaped plungers 106 with the different predefined shapes 136, 116 and 126 are compactly assembled into a single stacked tower assembly 100 for storage when the food processing assembly 100 is not in use. Of course, this in only one example of three stacked molds and plungers and it should be clear to anyone reading this that the food processing assembly tower 100 can have fewer or more molds 104 and plungers 106 and still be within the scope of the present disclosure. The arrangements and order and the shapes can also vary and the disclosure is not limited to that shown in the exemplary embodiment of FIGS. 4A and 4B.

FIG. 5 includes FIG. 5A that is a top perspective view of a round food mold body, FIG. 5B that is a top perspective view of a round food molding plunger body, and FIG. 5C that is a top perspective view of an attachable food mold face plate for the food molding plunger body, and FIG. 5D is a bottom perspective view of the attachable food mold face plate of FIG. 5C, each according to one set of exemplary embodiments. In this embodiment, the mold 110 is similar to the above described molds 104 and can have any shape of cavity 120 similar to that described above with regard to cavities 114, 124 and 134, by way of examples. In this example, the illustrated cavity is a large circle cavity 120 similar to that shown in FIG. 1B but is not limited thereto. This embodiment includes plunger 106 as shown in FIG. 5B with the handle 107. However, as different from those described above, the assembly of the plunger 106 as shown in FIG. 5B does not include a molding surface but rather includes a top surface 142 and a bottom surface 140, and defines an outer peripheral surface 126 that includes one or more plunger texture plate attachments 148. As shown in FIG. 5B, the plunger texture plate attachments 148 can be a one or more indentations, holes, raised surfaces or bumps or snap fixtures or ridges, by way of examples. The plunger texture plate 150 includes a texture surface 152 that includes one or more predefined molding texture features 160 that can be raised or lowered portions of the surface 152, designed and arranged to impart a predefined texture or pattern or symbol or text onto the top surface of the food product when the food product is pressed using the plunger 106. The plunger texture plate 150 can include a bottom surface or cavity 157 with an outer skirt 153 that is dimensioned and configured for encircling about the outer peripheral 126 of the upper mold body 106. One or more attachment texture plate fixture attachments 156, 158 formed on the skirt 153 and positioned to mate with or engage the one or more plunger texture plate attachments 148 of the plunger 106.

FIGS. 6, 7, 8, 9 and 10 includes FIGS. 6A, 7A, 8A, 9A, and 10A that are each top perspective views of a unibody or monolithic food mold 104, but with each having a different predefined molding cavity 114. FIG. 6A illustrates the mold 104 with three slider shaped cavities 134, FIG. 7A illustrates the mold 104 with a single rib shaped cavity 164 and top surface 146 with a formed outer peripheral edge 144 formed for insertion into a indent or outer peripheral edge cavity of a bottom surface of a mating or stackable adjacent mold 104. FIG. 8A is a mold 104 with a rib shaped cavity 114, FIG. 9A is a mold 104 with a helmet shaped cavity 114 and FIG. 10A is a mold with a dinosaur head shaped cavity 114.

As described above, each of the different shaped mold cavities 114 as shown in FIGS. 6A, 7A, 8A, 9A and 10A will have a substantially similarly shaped food plunger and these are shown in FIGS. 6B, 7B, 8B, 9B and 10B. FIG. 6B illustrates the plunger 106 with a small round slider shape 136, FIG. 7A illustrates the plunger 106 with a single rib shape 166, FIG. 8A is a plunger 106 with a rib shape 116 and having an upper surface 170 and a lower textured molding surface 171. FIG. 9B is a plunger 106 with a helmet shape 116 and FIG. 10A is a plunger 106 with a dinosaur head shape 116. As described, each of these examples of plungers 106 are substantially similarly shaped and dimensioned to fit within the cavity 114 of the corresponding mold 104 for pressing of the food product therein as well as for storage. Further, each of the plungers 106, in one embodiment, will have a vertical height from the texture or bottom surface 171 to the top of the handle 107 that is less than the total thickness or height of the similarly shaped mold 104 such that the plungers 106 can be placed within the corresponding cavity 114 and the plungers 106 do not extend below or above the bottom surface or the top surface of the mold 104. In this manner, when assembled with each plunger 106 within the cavity 114 of each corresponding and similarly shaped cavity 114 of each mold, the molds 104 can be stacked to form the tower assembly 100 for easy and compact storage when the food processing assembly is not in use.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A food preparation assembly comprising:
a plurality of food mold bodies with each having an outer body and a through cavity with a different predefined molding shape; and
a plurality of molding plungers with each having a top side with a handle and a bottom plunger body having a shape substantially similar to a different one of the predefined shapes of one of the plurality of mold bodies and dimensioned for insertion into the similarly shaped mold body cavities, and a bottom molding surface for contacting the food when placed within the cavity.

2. The food preparation assembly of claim 1, wherein each of the plurality of food mold bodies has a mating feature in proximity to a perimeter for selectable coupling to the adjacent food molding body for selectable stacking the plurality of food mold bodies into a stacked tower assembly.

3. The food preparation assembly of claim 1, further comprising:
a base plate having a substantially planar profile with a top side defining a top surface and a bottom side defining a bottom surface that is differently textured than the top surface, at least one of the top and bottom surfaces includes a mating feature proximate to a perimeter, wherein each food mold body having a mating feature in proximity to a perimeter for selectable coupling to the adjacent food molding body and to the base plate when coupled thereto into the assembled tower assembly.

4. The food preparation assembly of claim 3 is configured and dimensioned for the assembly to be assembled with a first mold body selectively mounted onto the top molding surface of the base plate with the first molding plunger positioned within the cavity thereof and the second mold body selectively mounted to a top surface of the second mold body with the second molding plunger positioned within the cavity thereof, wherein the assembled food preparation assembly forms a stack tower assembly on the base plate with only outer surface portions of the first and second mold bodies being visible from a side view and the first and second molding plungers being secured within each of the cavities of each of the first and second mold bodies.

5. The food preparation assembly of claim 3 wherein the base plate and the first mold each have an outer shape defined by a perimeter that is selected from the group that includes a circle and an octagon.

6. The food preparation assembly of claim 3 wherein the base plate includes a drip trough feature about a periphery on at least the first side or the second side.

7. The food preparation assembly of claim 1 wherein each food molding plunger has a vertical dimension that is substantially equivalent to or slightly less than the vertical dimension of the food mold body having the similarly shaped cavity.

8. The food preparation assembly of claim 1 wherein each of the cavities has a different predefined shape selected from the group consisting of a large patty circle, on or more small patty or slider circles, a rib, a chop, a helmet, a sports ball including a football, and an animal including a dinosaur.

9. The food preparation assembly of claim 1 wherein each molding plunger has an upper body with the handle and a plurality of selectively attachable bottom bodies with each having a different bottom molding surface, the bottom body being selectively attachable to a lower portion of the upper body by a one or more selective attachment mechanisms.

10. A food preparation assembly comprising:
a base plate having a substantially planar profile with a top molding surface and a bottom molding surface, at least one of the top and bottom molding surface include a mating feature proximate to a perimeter;
an outer mold body having a bottom surface with a mating feature couplable to the mating feature of the base plate and having a cavity with a first predefined shape;
a plurality of inner mold bodies with each configured for usable placement and selective retention within the cavity of the outer mold body and each having a predefined inner moldable shape cavity of a different molding shape; and
a plurality of molding plungers with each having a top side with a handle and a bottom plunger body that has a shape substantially similar to a different one of the moldable shaped cavities of one of the inner mold bodies, and each having a bottom molding surface.

11. The food preparation assembly of claim 10 wherein the second molding plunger with the handle has a vertical dimension that is substantially equivalent or slightly less than the vertical dimension of the outer mold body.

12. The food preparation assembly of claim 10 wherein each of the predefined shapes of the mold bodies and the corresponding molding plunger is selected from the group consisting of a large patty circle, a small patty or slider circle, a rib, and a chop, a helmet, a sports ball including a football, and an animal including a dinosaur.

13. The food preparation assembly of claim 10 wherein the base plate includes a drip trough feature about a periphery on at least the first side or the second side.

14. The food preparation assembly of claim 10 wherein the base plate and the first mold each have an outer shape defined by a perimeter that is selected from the group that includes a circle and an octagon.

15. The food preparation assembly of claim 10 wherein the first molding surface of the base plate is substantially smooth and the second molding surface of the base plate has a chopped texture.

16. A food preparation method comprising:
placing a mold body at least one of a working surface or a base placed upon the working surface, the mold body having a cavity with a predefined shape;
placing a food product in the cavity of the mold body;
placing a mold plunger onto the food product within the mold body cavity, the plunger have a shape that is substantially similar to that and which conforms to the shape of the predefined shape of the mold body;
applying downward molding pressure to a handle of the mold plunger;
removing the mold plunger after applying the downward molding pressure; and
removing the mold body from about the molded food product.

17. The food preparation method of claim 16, further comprising placing a base on a working surface and wherein placing the mold body is placing the mold body on the base.

18. The food preparation method of claim 16, further comprising;
prior to the step of placing the base on the working surface, disassembling a stack of a plurality of mold bodies with each having a differently shaped molding cavity, each stacked on top of each other and all of which are stacked on top of the base forming a tower assembly, and further removing a plurality of molding plungers from each of the molding cavities with each having a shape that conforms substantially with a different one of the shaped molding cavities.

19. The food preparation method of claim 16, further comprising:
prior to the placing the mold plunger, selectively attaching a molding surface body to an upper body of the molding plunger that defines a top handle.

20. The food preparation method of claim 16, further comprising, at the beginning of the method as the first step, disassembling a stacked tower assembly having a base on the bottom, two or more stacked mold bodies, each mold body having a mold body cavity defining a different mold shape, and two or more food mold plungers, each having an outer shape that is substantially similar to one body cavities of one of the mole bodies, each of the two or more food mold plungers being positioned within the respectively shaped cavity in the stacked tower assembly.

21. A food preparation method comprising:
placing a base on a working surface;
placing an outer mold body on the working surface, wherein the outer mold body has a cavity for receiving an inner mold body with a predefined molding cavity shape;
placing an inner mold body with the molding cavity shape within the cavity of the outer mold body;
placing a food product in the molding cavity of the inner mold body;
placing a mold plunger onto the food product within the inner mold body cavity, the plunger have a shape that is substantially similar to that and which conforms to the shape of the predefined molding cavity shape of the inner mold body;
applying downward molding pressure to a handle of the mold plunger;
removing the mold plunger after applying the downward molding pressure; and
removing the inner mold body from about the molded food product.

22. The method of claim 21, further comprising:
after removing the inner mold body from the molded food product, removing the inner mold body from the outer mold body.

23. The method of claim 21, further comprising, at the beginning of the method as the first step, disassembling a stacked tower assembly having the base on the bottom, two or more stacked mold bodies, each mold body having a mold body cavity defining a different mold shape, and two or more food mold plungers, each having an outer shape that is substantially similar to one body cavities of one of the mole bodies, each of the two or more food mold plungers being positioned within the respectively shaped cavity in the stacked tower assembly.

24. The method of claim 21, further comprising;
placing a second inner mold body configured for usable placement and selective retention within the cavity of the outer mold body and having a second moldable shape cavity that is different from the shape of the first moldable shape cavity;
placing a second food product in the second molding cavity of the second inner mold body;
placing a second molding plunger having a top side with a handle and a bottom plunger body having a shape substantially similar to the moldable shape cavity of the second inner mold body;
applying a second downward molding pressure to a handle of the second mold plunger;
removing the second mold plunger after applying the second downward molding pressure;
removing the second inner mold body from about the second molded food product; and
removing the second inner mold body from the second outer mold body.

25. A food preparation assembly comprising:
a selectably assembled tower assembly having a plurality of food mold bodies stacked together, each food mold body having an outer body and a through molding cavity with each having a different predefined molding shape, the tower assembly including a plurality of food molding plungers with each having a shape that is substantially similar to one of the predefined shapes of each molding cavity and each of the plurality of food molding plungers being selectably positioned and inserted within the correspondingly shaped molding cavity when assembled in the assembled tower assembly, the tower assembly being selectably disassembled into separately usable food mold bodies with separately usable food molding plungers.

26. The food preparation assembly of claim 25, further comprising a base plate having a substantially planar profile with a top side defining a top surface and a bottom side defining a bottom surface, at least one of the top and bottom surface including a mating feature proximate to a perimeter; wherein each food mold body having a mating feature in proximity to a perimeter for selectably coupling to the adjacent food molding body and to the base plate when coupled thereto into the assembled tower assembly.
